(19) United States
(12) Patent Application Publication
(10) Pub. No.: US 2025/0180931 A1
(43) Pub. Date: Jun. 5, 2025

(54) WEARABLE APPARATUS

(71) Applicant: AAC ACOUSTIC TECHNOLOGIES (SHENZHEN) CO., LTD., Shenzhen (CN)

(72) Inventor: Meng Lin, Shenzhen (CN)

(21) Appl. No.: 18/640,018

(22) Filed: Apr. 19, 2024

Related U.S. Application Data
(63) Continuation of application No. PCT/CN2023/135282, filed on Nov. 30, 2023.

(51) Int. Cl. G02C 11/00; G02B 27/01

(52) U.S. Cl. CPC G02C 11/10; G02B 27/0176; G02B 2027/0163; G02B 2027/0178

(57) ABSTRACT

A wearable apparatus is provided. The wearable apparatus includes a support, at least one first speaker, and the at least one second speaker. The at least one first speaker and the at least one second speaker are disposed in the support. When a user wears the wearable apparatus for using, the at least one second speaker respectively adjusts a waveform and a phase of a second sound wave signal according to sound wave features, such as waveform and phase, of a first sound wave signal. The second sound wave signal cancels at least a part of the first sound wave signal propagating in a second direction. Sound attenuation of the first sound wave signal in the second direction is increased, that is, the far-field isolation degree of the wearable device is improved through a cancellation effect of the at least one second speaker, a privacy effect thereof is better.

### TECHNICAL FIELD

The present disclosure relates to the field of wearable apparatus technology, and in particular to a wearable apparatus.

### BACKGROUND

When a wearable apparatus works, a difference between a sound amplitude of a speaker of a wearable apparatus received by an ear of a user wearing the wearable apparatus and a sound amplitude of the speaker of the wearable apparatus received by an ear of a user standing at a distance from the wearable apparatus is referred to as far-field isolation degree, and the greater the far-field isolation degree, the smaller sound leakage defect of the wearable apparatus is, so that a privacy effect of the wearable apparatus is better. It can be understood that a propagation of sound is affected by distance, and a sound amplitude thereof is naturally attenuated as the distance increases, therefore, an attenuation degree of the sound amplitude thereof needs to increase for improving the privacy effect of the wearable apparatus.

In the related art, a rear cavity balance hole is defined on the wearable apparatus, a reverse sound wave emitted from the rear cavity balance hole and a forward sound wave emitted from a sound outlet of a primary speaker cancel out each other at an end distal from the ear of the user, so that a sound amplitude received at the end distal from the ear of the user is reduced and the far-field isolation degree is further improved. However, once the wearable apparatus is improved to have such structure, a structure of the wearable apparatus is shaped and cannot be further optimized, and effective sound attenuation cannot be achieved.

### SUMMARY

Based on above, the present disclosure provides a wearable apparatus including at least one second speaker, the at least second speaker is capable of adjusting phases and waveforms according to sound wave features of a first sound wave signal to cancel a part of the first sound wave signal, so that a far-field isolation degree of the wearable apparatus is improved.

The present disclosure provides the wearable apparatus, including a support, at least one first speaker, and the at least one second speaker. The at least one first speaker and the at least one second speaker are disposed in the support. The at least one first speaker outputs a first sound wave signal, propagation directions of the first sound wave signal includes a first direction and a second direction, an included angle θ between the first direction and the second direction satisfies 90°<0≤180°. The at least one second speaker is disposed on one side of the at least one first speaker, the one side of the at least one first speaker is in the second direction. The at least one second speaker outputs a second sound wave signal, a propagation direction of the at least one second speaker is the second direction, a waveform of the second sound wave signal is the same as a waveform of the first sound wave signal, and a phase of the second sound wave is opposite to a phase of the first sound wave.

As an improvement, the wearable apparatus further includes a main body. The support includes a first support and a second support, the first support and the second support are respectively rotatably connected to two sides of the main body. Two first speakers and two second speakers are provided, a first one of the two first speakers and a first one of the two second speakers are disposed in the first support, a second one of the two first speakers and a second one of the two second speakers are disposed in the second support.

As an improvement, an accommodating cavity is defined in the first support and the second support, the two first speakers and the two second speakers are disposed in the accommodating cavity.

As an improvement, the wearable apparatus further includes a driving unit, the driving unit is disposed in the first support and/or the second support.

As an improvement, the driving unit includes a central processing unit, an audio codec, and a driving amplifier array. An output end of the central processing unit is connected to an input end of the audio codec, an output end of the audio codec is connected to an input end of the driving amplifier array, and an output end of the driving amplifier array is respectively connected to the two first speakers and the two second speakers.

As an improvement, the wearable apparatus further includes a power supply module. The power supply module is respectively connected to the driving unit, the two first speakers, and the two second speakers.

As an improvement, the wearable apparatus further includes a charging module, the charging module is connected to the power supply module.

As an improvement, the wearable apparatus further includes a rotating shaft assembly. The first support is connected to the main body through the rotating shaft assembly, and the second support is connected to the main body through the rotating shaft assembly.

As an improvement, a direction the first support opposite to the second support is the first direction.

As an improvement, the wearable apparatus is selected from an augmented reality (AR) headset, a virtual reality (VR) headset, a mix reality (MR) headset, smart glasses, and a wearable speaker.

Beneficial effects of the present disclosure are as follows.

According to the wearable apparatus of the present disclosure, when a user wears the wearable apparatus for using, the first direction is a direction propagating sound to an ear of the user, the second direction is a direction propagating the sound away from the ear of the user, the at least one first speaker is a main sound source of the wearable apparatus and is configured to transmit an audible sound to the ear of the user. The at least one second speaker is capable of adjusting the phase and the waveform of the second sound wave signal according to sound wave features of the first sound wave signal output by the at least one first speaker, after adjustment of the at least one second speaker, the waveform of the second sound wave signal is the same as the waveform of the first sound wave signal, and the phase of the second sound wave is opposite to the phase of the first sound wave, so that the second sound wave signal cancels at least a part of the first sound wave signal propagating in the second direction. Therefore, sound attenuation of the first sound wave signal in the second direction is increased, that is, the far-field isolation degree of the wearable device is improved through a cancellation effect of the at least one second speaker, a privacy effect thereof is better.

### BRIEF DESCRIPTION OF DRAWINGS

FIG. 1 is a schematic diagram of a support of a wearable apparatus according to one embodiment of the present disclosure.

FIG. 2 is a distribution diagram of a first direction and a second direction of the wearable apparatus according to one embodiment of the present disclosure.

FIG. 3 is a test result diagram of embodiment 1 and comparative example 1 of the present disclosure.

Reference numerals in the drawings: 1. first support; 11. accommodating cavity; 2. second support; 3. first speaker; 4. second speaker; 5. rotating shaft assembly.

### DETAILED DESCRIPTION OF EMBODIMENTS

In order to better understand technical solutions of the present disclosure, embodiments of the present disclosure are described in detail below with reference to accompanying drawings.

It should be understood that the described embodiments are only a part but not all of the embodiments of the present disclosure. All other embodiments obtained by those who skilled in the art based on the embodiments of the present disclosure without creative efforts shall fall within a protection scope of the present disclosure.

Terminologies used in the embodiments of the present disclosure are for a purpose of describing particular embodiments only and is not intended to be limiting of the present disclosure. As used in the embodiments of the present disclosure and appended claims, singular forms “a”, “the”, and “cited” are also intended to include plural forms, unless context clearly indicates other meanings.

It should be understood that term “and/or” used herein is merely an association relationship describing associated objects, indicating that there may be three relationships, for example, A and/or B may indicate three cases that A exists alone, A and B exist, and B exists alone. In addition, a character “/” in the specification generally indicates an “or” relationship between the associated objects.

It should be noted that terms, such as “upper”, “lower”, “left”, and “right” described in the embodiments of the present disclosure are described by using an angle shown in the accompanying drawings, and should not be understood as a limitation to the embodiments of the present disclosure. In addition, in the context, it should also be understood that when an element is connected “on” or “below” another element, it can not only be directly connected “on” or “below” another element, or may be indirectly connected “on” or “below” another element through an intermediate element.

When a wearable apparatus works, a difference between a sound amplitude of a speaker of a wearable apparatus received by an ear of a user wearing the wearable apparatus and a sound amplitude of the speaker of the wearable apparatus received by an ear of a user standing at a distance from the wearable apparatus is referred to as far-field isolation degree, and the greater the far-field isolation degree, the smaller sound leakage defect of the wearable apparatus is, so that a privacy effect of the wearable apparatus is better. It can be understood that a propagation of sound is affected by distance, and a sound amplitude thereof is naturally attenuated as the distance increases, therefore, an attenuation degree of the sound amplitude thereof needs to increase for improving the privacy effect of the wearable apparatus.

In the related art, a rear cavity balance hole is defined on the wearable apparatus, a reverse sound wave emitted from the rear cavity balance hole and a forward sound wave emitted from a sound outlet of a primary speaker cancel out each other at an end distal from the ear of the user, so that a sound amplitude received at the end distal from the ear of the user is reduced and the far-field isolation degree is further improved. However, once the wearable apparatus is improved to have such structure, a structure of the wearable apparatus is shaped and cannot be further optimized, and effective sound attenuation cannot be achieved.

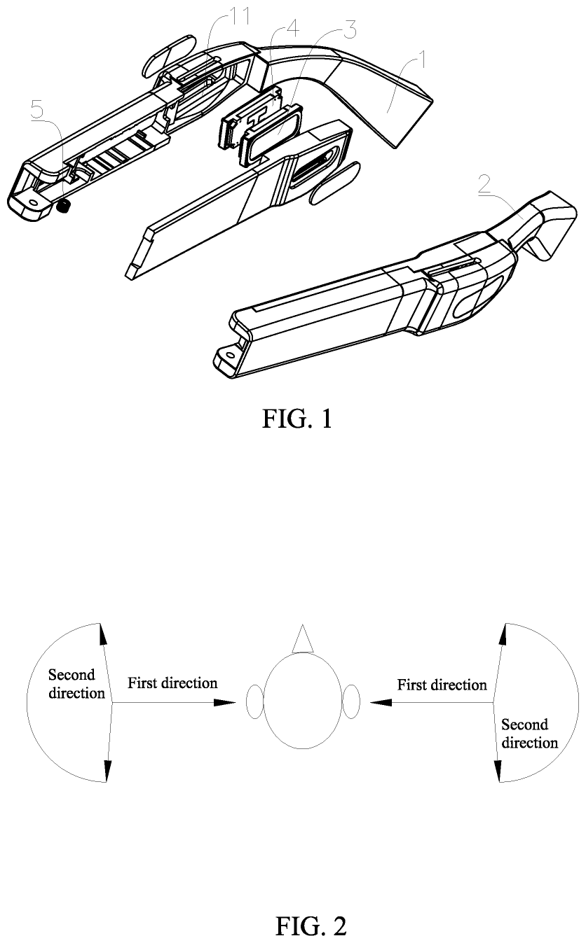

Based on above, the present disclosure provides a wearable apparatus, as shown in FIGS. 1 and 2, including a support. At least one first speaker 3 and at least one second speaker 4 are disposed in the support. The at least one first speaker 3 outputs a first sound wave signal, propagation directions of the first sound wave signal includes a first direction and a second direction, an included angle θ between the first direction and the second direction satisfies 90°<0≤180°. The at least one second speaker 4 is disposed on one side of the at least one first speaker 3, the one side of the at least one first speaker 3 is in the second direction. The at least one second speaker 4 outputs a second sound wave signal, a propagation direction of the at least one second speaker is the second direction, a waveform of the second sound wave signal is the same as a waveform of the first sound wave signal, and a phase of the second sound wave is opposite to a phase of the first sound wave.

According to the wearable apparatus of the present disclosure, when a user wears the wearable apparatus for using, the first direction is a direction propagating sound to an ear of the user, the second direction is a direction propagating the sound away from the ear of the user, the at least one first speaker 3 is a main sound source of the wearable apparatus and is configured to transmit an audible sound to the ear of the user. The at least one second speaker 4 is capable of adjusting the phase and the waveform of the second sound wave signal according to sound wave features of the first sound wave signal output by the at least one first speaker 3, after adjustment of the at least one second speaker 4, the waveform of the second sound wave signal is the same as the waveform of the first sound wave signal, and the phase of the second sound wave is opposite to the phase of the first sound wave, so that the second sound wave signal cancels at least a part of the first sound wave signal propagating in the second direction. Therefore, sound attenuation of the first sound wave signal in the second direction is increased, that is, the far-field isolation degree of the wearable device is improved through a cancellation effect of the at least one second speaker, a privacy effect thereof is better.

In the embodiments of the present disclosure, the wearable apparatus is selected from an augmented reality (AR) headset, a virtual reality (VR) headset, a mix reality (MR) headset, smart glasses, a wearable speaker, etc., which may be selected according to actual needs and is not limited herein.

One embodiment of the present disclosure takes AR audio glasses as an example for description.

The AR audio glasses include a main body and the support. The support includes a first support 1 and a second support 2, the first support 1 and the second support 2 are respectively rotatably connected to two sides of the main body. Specifically, the wearable apparatus further includes a rotating shaft assembly 5. The first support 1 is connected to the main body through the rotating shaft assembly 5, and the second support 2 is connected to the main body through the rotating shaft assembly 5. It can be understood that, through the rotating shaft assembly 5, when the user needs to store the AR audio glasses, the first support 1 and the second support 2 are folded in a direction close to the main body, thereby reducing a storage space of the AR audio glasses and being convenient for the user to carry or store the AR audio glasses.

In the embodiments of the present disclosure, a direction the first support 1 opposite to the second support 2 is the first direction. That is, when the user wears the wearable apparatus, a wearing direction facing the ear of the user is the first direction, and a wearing direction distal from the ear of the user is the second direction.

It should be noted that the included angle θ between the first direction and the second direction satisfies 90°<0≤180°. Specifically, the θ is selected from 10°, 40°, 70°, 100°, 130°, 160°, 180°, etc., or may be other values within a range, which may be selected according to actual needs and is not limited herein. It may be understood that, along a separation plane of the at least one first speaker 3 and the at least one second speaker 4, a direction of a first side of the separation plane close to the ear of the user is a propagation direction of the first direction, and a direction of a second side of the separation plane distal from the ear of the user is a propagation direction of the second direction, that is, the first direction is any direction on a first hemispherical surface taking the ear of the user as a sphere center and radiating toward the ear of the user, and the second direction is any direction on a second hemispherical surface taking the ear of the user as a sphere center and radiating away from an ear of the user. As an improvement, the included angle θ between the first direction and the second direction satisfies 90°<0≤180°. As an improvement, the included angle θ between the first direction and the second direction is 180°.

In the embodiments of the present disclosure, an accommodating cavity 11 is defined in the first support 1 and the second support 2, the at least one first speaker 3 and the at least one second speaker 4 are disposed in the accommodating cavity 11. It should be noted that positions of the at least one first speaker 3 and the at least one second speaker 4 should be that when the user wears the AR audio glasses, the position of the at least one first speaker 3 corresponds to the ear of the user.

In the embodiments of the present disclosure, the at least one first speaker 3 is defined as a primary speaker, the at least one second speaker 4 is defined as a secondary speaker, the primary speaker converts an electrical signal into the first sound wave signal, that is, an audio electrical power signal within a range is converted into an audible sound having a small distortion and a sufficient sound pressure level through an energy exchange manner, that is, a propagation direction of the audible sound includes a propagation direction toward the ear of the user and a propagation direction away from the ear of the user, and in such process, the first sound wave signal propagated in the propagation direction away from the ear of the user is reduced to further reduce privacy of the wearable apparatus, so that sound insulation of the wearable apparatus is poor. Therefore, the at least one second speaker 4 is further provided, the at least one second speaker 4 outputs the second sound wave signal thereof having the same waveform and opposite phase with the first sound wave signal according to the sound wave features, such as waveform and phase, of the first sound wave signal. The second sound wave signal propagates in the second direction, thereby canceling the first sound wave signal propagated to the end distal from the ear of the user, so that privacy of the AR audio glasses is improved.

It should be noted that an analysis process of the at least one second speaker 4 on the first sound wave signal is an artificial intelligence (AI) analysis process, so that the waveform and the phase of the second sound wave signal are adjusted according to different phases and waveforms of the at least one first sound wave signal to adapt to different first sound wave signals, such active adjustment process better improves the far-field isolation degree of the wearable apparatus.

In the embodiments of the present disclosure, a working process of the at least one first speaker 3 and the at least one second speaker 4 is implemented by a driving module. The driving unit is disposed in the first support 1 and/or the second support 2. The driving unit includes a central processing unit, an audio codec, and a driving amplifier array. An output end of the central processing unit is connected to an input end of the audio codec, an output end of the audio codec is connected to an input end of the driving amplifier array, and an output end of the driving amplifier array is respectively connected to the at least one first speaker 3 and the at least one second speaker 4. It may be understood that, the at least one first speaker 3 and the at least one second speaker 4 output sound wave signals having different amplitudes, different phases, and different waveforms through the driving module.

In the embodiments of the present disclosure, the wearable apparatus further includes a power supply module and a charging module. The power supply module is respectively connected to the driving unit, the at least one first speaker 3, and the at least one second speaker 4. The charging module is connected to the power supply module. It may be understood that the power supply module supplies current for the driving module, the at least one first speaker 3, and the at least one second speaker to work, and the charging module charges the power supply module.

Following describes technical solutions of the present disclosure with reference to specific embodiments.

### Embodiment 1

According to the present disclosure, the wearable apparatus includes the at least one first speaker 3 and the at least one second speaker 4 is fixed on two ears of an artificial head, a frequency band of the at least one first speaker is 100 Hz˜10 kHz, and a first microphone is disposed in a left ear of the two ears of the artificial head.

### Comparative Example 1

Compared with the embodiment 1, a wearable apparatus provided in the comparative example 1 does not include a second speaker, and only include a first speaker.

### Test

In a direction at 270° taking the artificial head as a circle center, that is, in a direction of the left ear of the two ears of the artificial head, a second microphone is provided at a distance from the artificial head 60 cm. An isolation degree between each frequency band of the first microphone and the second microphone is tested, i.e. a sound pressure level tested at a portion at the distance from the artificial head 60 cm minuses a sound pressure level tested in the two ears of the artificial head.

### Test Result

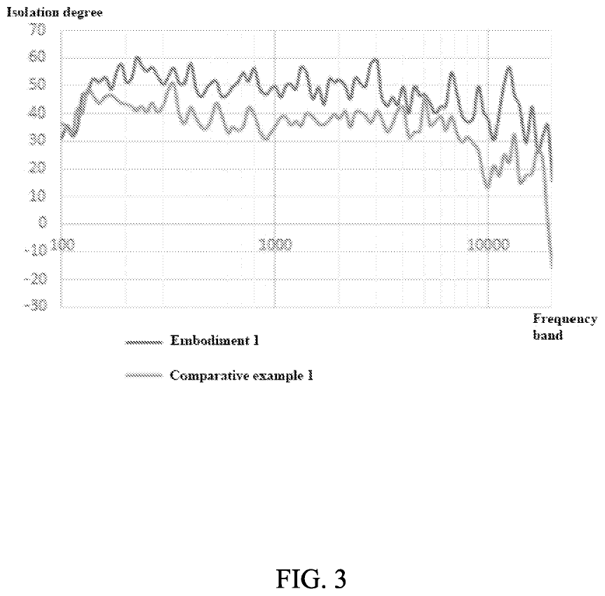

FIG. 3 is a test result diagram of the embodiment 1 and the comparative example 1 of the present disclosure, as shown in FIG. 3, it can be taken from a test result of the embodiment 1 and the comparative example 1 that after the second speaker is provided, an isolation degree of the wearable apparatus provided in the embodiment 1 of the present disclosure is significantly higher that an isolation degree of the wearable apparatus provided in the comparative example 1 within a test frequency band ranged from 100 Hz to 10 kHz. Therefore, after the at least one second speaker provided in the wearable apparatus of the present disclosure, the at least one second speaker is capable of adjusting the phase and the waveform of the second sound wave signal according to sound wave features of the first sound wave signal output by the at least one first speaker, after adjustment of the at least one second speaker, the waveform of the second sound wave signal is the same as the waveform of the first sound wave signal, and the phase of the second sound wave is opposite to the phase of the first sound wave, so that the second sound wave signal cancels at least a part of the first sound wave signal propagating in the second direction. In this way, sound attenuation of the first sound wave signal in the second direction is increased, as the distance increases, a sound attenuation degree is increased, so that the far-field isolation degree of the wearable device is improved through the cancellation effect of the at least one second speaker, the privacy effect thereof is better.

Structures, features, and effects of the present disclosure are described in detail above according to the embodiments shown in the drawings, but the above are only preferred embodiments of the present disclosure, and the present disclosure is not limited to an implementation scope shown in the drawings, and any changes made according to a concept of the present disclosure or equivalent embodiments modified to equivalent changes still fall within a protection scope of the present disclosure without departing from a spirit covered by the specification and the drawings of the present disclosure.

What is claimed is:

1. A wearable apparatus, comprising:
a support;
at least one first speaker; and
at least one second speaker;
wherein the at least one first speaker and the at least one second speaker are disposed in the support; the at least one first speaker outputs a first sound wave signal, propagation directions of the first sound wave signal comprises a first direction and a second direction, an included angle θ between the first direction and the second direction satisfies 90°<0≤180°; and
the at least one second speaker is disposed on one side of the at least one first speaker, the one side of the at least one first speaker is in the second direction; the at least one second speaker outputs a second sound wave signal, a propagation direction of the at least one second speaker is the second direction, a waveform of the second sound wave signal is the same as a waveform of the first sound wave signal, and a phase of the second sound wave is opposite to a phase of the first sound wave.

2. The wearable apparatus according to claim 1, further comprising:
a main body;
wherein the support comprises a first support and a second support, the first support and the second support are respectively rotatably connected to two sides of the main body; two first speakers and two second speakers are provided, a first one of the two first speakers and a first one of the two second speakers are disposed in the first support, a second one of the two first speakers and a second one of the two second speakers are disposed in the second support.

3. The wearable apparatus according to claim 2, wherein an accommodating cavity is defined in the first support and the second support, the two first speakers and the two second speakers are disposed in the second accommodating cavity

4. The wearable apparatus according to claim 2, further comprising:
a driving unit;
wherein the driving unit is disposed in the first support and/or the second support.

5. The wearable apparatus according to claim 4, wherein the driving unit comprises a central processing unit, an audio codec, and a driving amplifier array; an output end of the central processing unit is connected to an input end of the audio codec;
an output end of the audio codec is connected to an input end of the driving amplifier array; and an output end of the driving amplifier array is respectively connected to the two first speakers and the two second speakers.

6. The wearable apparatus according to claim 4, further comprising:
a power supply module;
wherein the power supply module is respectively connected to the driving unit, the two first speakers, and the two second speakers.

7. The wearable apparatus according to claim 6, further comprising:
a charging module;
wherein the charging module is connected to the power supply module.

8. The wearable apparatus according to claim 2, further comprising:
a rotating shaft assembly;
wherein the first support is connected to the main body through the rotating shaft assembly, and the second support is connected to the main body through the rotating shaft assembly.

9. The wearable apparatus according to claim 2, wherein a direction the first support opposite to the second support is the first direction.

10. The wearable apparatus according to claim 1, wherein the wearable apparatus is selected from an augmented reality (AR) headset, a virtual reality (VR) headset, a mix reality (MR) headset, smart glasses, and a wearable speaker.
